(19) United States
(12) Patent Application Publication
(10) Pub. No.: US 2015/0241110 A1
(43) Pub. Date: Aug. 27, 2015

(54) Refrigeration Compressor Feet Mounting

(71) Applicant: Carrier Corporation, Farmington, CT (US)

(72) Inventors: Frederick L. Miller, Syracuse, NY (US); Igor V. Korolev, Cicero, NY (US)

(73) Assignee: Carrier Corporation, Farmington, CT (US)

(21) Appl. No.: 14/422,940

(22) PCT Filed: Jul. 3, 2013
(86) PCT No.: PCT/US2013/049274

§ 371 Date: Feb. 20, 2015

Related U.S. Application Data
(60) Provisional application No. 61/696,716, filed on Sep. 4, 2012.

(51) Int. Cl. F25D 19/00; F16M 1/02; F04B 35/04

(52) U.S. Cl. CPC F25D 19/00; F04B 35/04; F16M 1/02

(57) ABSTRACT

A compressor (20) has a case (22) and a pair of feet (70A, 70B). The feet are alternatively mountable in a first orientation and a second orientation orthogonal to the first orientation.

### CROSS-REFERENCE TO RELATED APPLICATION

Benefit is claimed of U.S. patent application Ser. No. 61/696,716, filed Sep. 4, 2012, and entitled “Refrigeration Compressor Feet Mounting”, the disclosure of which is incorporated by reference herein in its entirety as if set forth at length.

### BACKGROUND

The present disclosure relates to refrigeration compressors. More particularly, it relates to reciprocating piston compressor mounting.

A variety of refrigerant compressor configurations are in common use. Among these configurations are: screw compressors; scroll compressors; and reciprocating piston compressors. One particular subfield of refrigeration systems is chiller systems where one or more compressors are mounted on a rack. Rack mounting of compressors may be used in other applications such as central compressors for distributed retail display cabinets.

Mounting is often on parallel mounting rails of the rack. During installation and removal of compressors, there may be a tendency of the compressor to partially fall between rails.

### SUMMARY

One aspect of the disclosure involves a compressor having a case and a pair of feet. The feet are alternatively mountable in a first orientation and a second orientation orthogonal to the first orientation.

In various implementations, the compressor may be a reciprocating compressor. An electric motor may be within the case for driving compression or external to the case. The feet may comprise bent sheet metal strips. The compressor may comprise a casting with internally-threaded mounting features. The feet may comprise complementary mounting features. The case internally threaded mounting features may include a first pair laterally spaced apart and a second pair laterally spaced apart and longitudinally spaced apart from the first pair. The feet complementary mounting features may comprise: a pair of holes mountable, respectively, to the first pair of internally threaded mounting features or the second pair of internally threaded mounting features in the first orientation; and at least two further holes mountable, in the second orientation, respectively to one of the internally threaded mounting features of the first pair and one of the internally threaded mounting features of the second pair. A first hole of said at least two further holes in the feet may be between the holes of the pair. The first hole may be exactly between the pair. The case may further comprise a shared boss bearing the mounting features. The feet may be secured to support rails, spanning a gap between the rails.

Other aspects of the disclosure involve a refrigeration system including such a compressor. The refrigeration system may include a recirculating flowpath through the compressor. A first heat exchanger may be positioned along the flowpath downstream of the compressor. An expansion device may be positioned along the flowpath downstream of the first heat exchanger. A second heat exchanger may be positioned along the flowpath downstream of the expansion device. The refrigerant charge may comprise at least 50% carbon dioxide by weight. The system may be a refrigerated transport system. The refrigerated transport system may further comprise a container. The second heat exchanger may be positioned to cool an interior of the container.

The system may be a fixed refrigeration system. The fixed refrigeration system may further comprise multiple refrigerated spaces. There may be a plurality of said second heat exchangers, each being positioned to cool an associated such refrigerated space.

Other aspects of the disclosure involve methods of manufacture/use of a plurality of the compressors. With a first said compressor, the pair of feet are mounted in the first orientation; and with a second said compressor, the pair of feet are mounted in the second orientation, the second compressor's case and feet being identical/interchangeable to the first compressor's case and feet.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is an exploded view of a compressor with feet in a longitudinal orientation.

FIG. 2 is a bottom view of the compressor of FIG. 1.

FIG. 3 is a further view of the compressor of FIG. 1 removably and replaceably mounted to a plurality of rails.

FIG. 4 is a bottom view of the compressor with the feet installed in a first transverse orientation.

FIG. 5 is a bottom view of the compressor with the feet installed in a second transverse orientation.

FIG. 6 is a bottom view of a foot of the compressor.

FIG. 7 is an end view of the foot.

FIG. 8 is a schematic view of a refrigeration system.

FIG. 9 is a schematic view of a fixed commercial refrigeration system.

Like reference numbers and designations in the various drawings indicate like elements.

### DETAILED DESCRIPTION

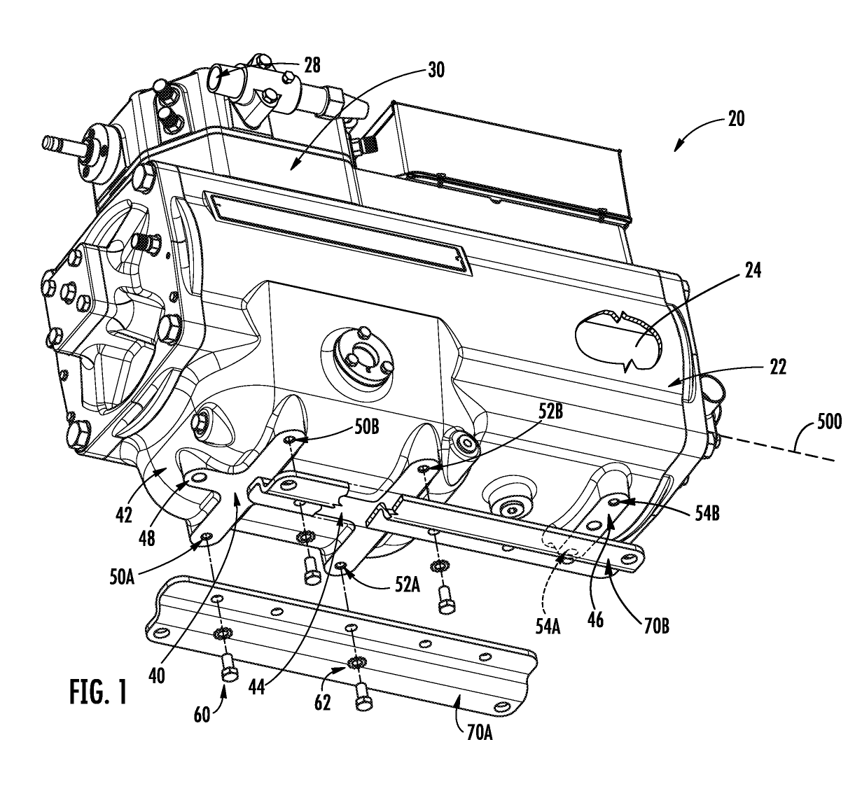

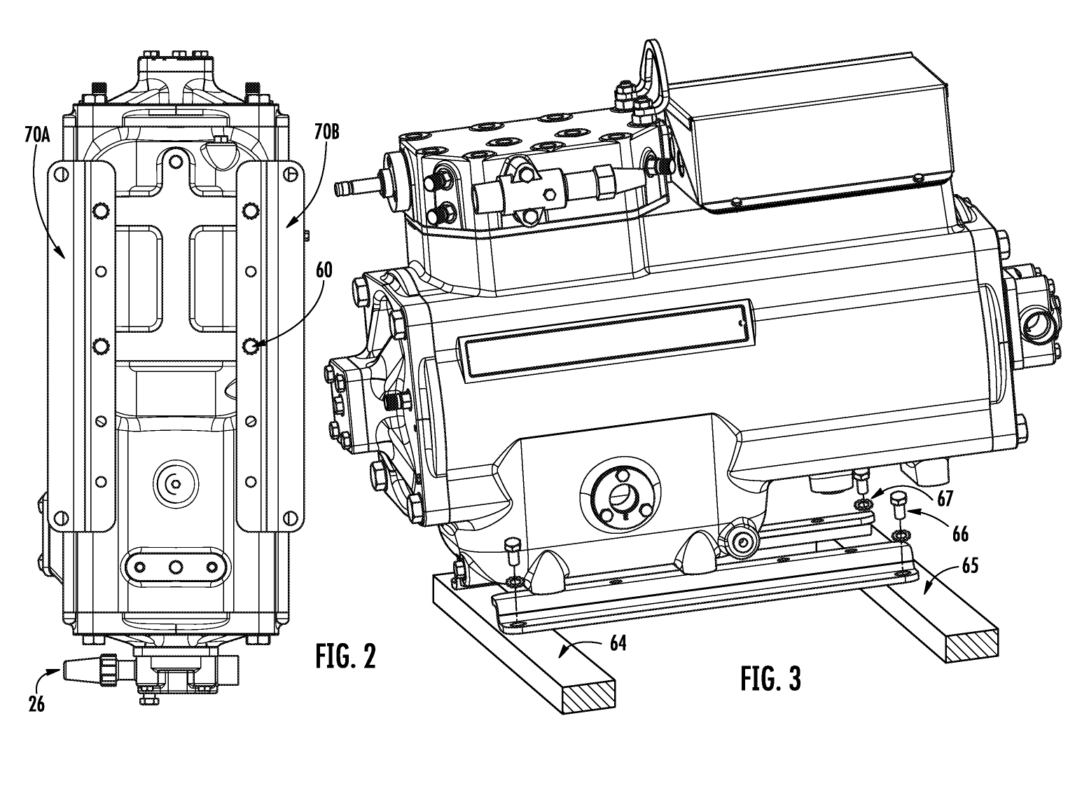

FIGS. 1 and 2 show an exemplary compressor 20. The compressor 20 has a housing (case) assembly 22. The exemplary compressor includes an electric motor 24 (e.g., having an axis 500 which also forms a compressor axis). The exemplary case 22 has a suction port (inlet) 26 (FIG. 2) and a discharge port (outlet) 28. The exemplary compressor is a reciprocating compressor wherein the housing defines a plurality of cylinders in a cylinder head section 30 of the housing. Each cylinder accommodates an associated piston (not shown) mounted for reciprocal movement at least partially within the cylinder. Exemplary multi-cylinder configurations include: in-line; V (vee); and horizontally opposed. Each of the cylinders includes a suction location and a discharge location. For example, the cylinders may be coupled in parallel so that the suction location is shared/common suction plenum fed by the suction port 26 and the discharge location is a shared/common discharge plenum feeding the discharge port 28. In other configurations, the cylinders may share suction locations/conditions but have different discharge locations/conditions. In other configurations, the cylinders may be in series. An exemplary fluorocarbon-based refrigerant is R-410A. An exemplary carbon dioxide (CO₂)-based (e.g., at least 50% CO₂ by mass/weight) refrigerant is R-744. Other refrigerants and other compressor configurations or types may be used.

The exemplary case includes a lower end or bottom 40 formed in a casting 42 (e.g., aluminum alloy, iron or steel). The casting includes a plurality of mounting features for mounting the compressor. Exemplary mounting features are internally threaded holes in bosses. As is seen in the example, several are merged. FIG. 1 shows a configuration wherein a pair of left and right forward mounting features 50A and 50B therebehind, and a second pair of intermediate mounting features 52A and 52B yet therebehind are all formed on a single island or super boss 44; whereas the rearmost pair of mounting features 54A and 54B are formed on a rear boss 46. The superboss also includes a a single forwardmost tooling hole 48 (initially cast and machined and used to register the casting for further machining operations). Alternative mounting features include bores receiving press-fit studs.

A pair of feet 70A and 70B (collectively or generically individually “70”) may be mounted to the mounting features. Exemplary mounting is via fasteners (e.g., bolts 60 with washers 62) extending through apertures in the feet. As is discussed further below, FIGS. 1-3 show one exemplary use configuration in which the feet are mounted longitudinally (parallel to the axis 500). In this configuration, FIG. 3 shows the feet bolted to support rails 64 and 65 of the environmental structure (e.g., compressor rack). The exemplary compressor rack has a forward transverse rail 64 and an aft transverse rail 65 and the forward end portions of the feet are secured to the forward rail and aft end portions of the feet are secured to the aft rail (e.g., via bolts 66 with washers 67 (discussed further below)). A series of such compressors may be mounted in an array along a common pair of such rails.

As is discussed further below, the configuration of FIG. 2 involves the foot 70A mounted to the pair of features 50A and 52A and the foot 70B mounted to the pair of features 50B and 52B so that the feet are essentially parallel to the compressor axis 500. As is discussed further below, the exemplary feet and mounting features provide for alternative transverse mounting of the feet. Transverse mounting may be useful with longitudinal rack rails. By maintaining the feet transverse to the rails, stability may be improved by reducing the tendency of the compressor to partially fall between or aside the rails and preventing the feet sides from catching on the rail sides.

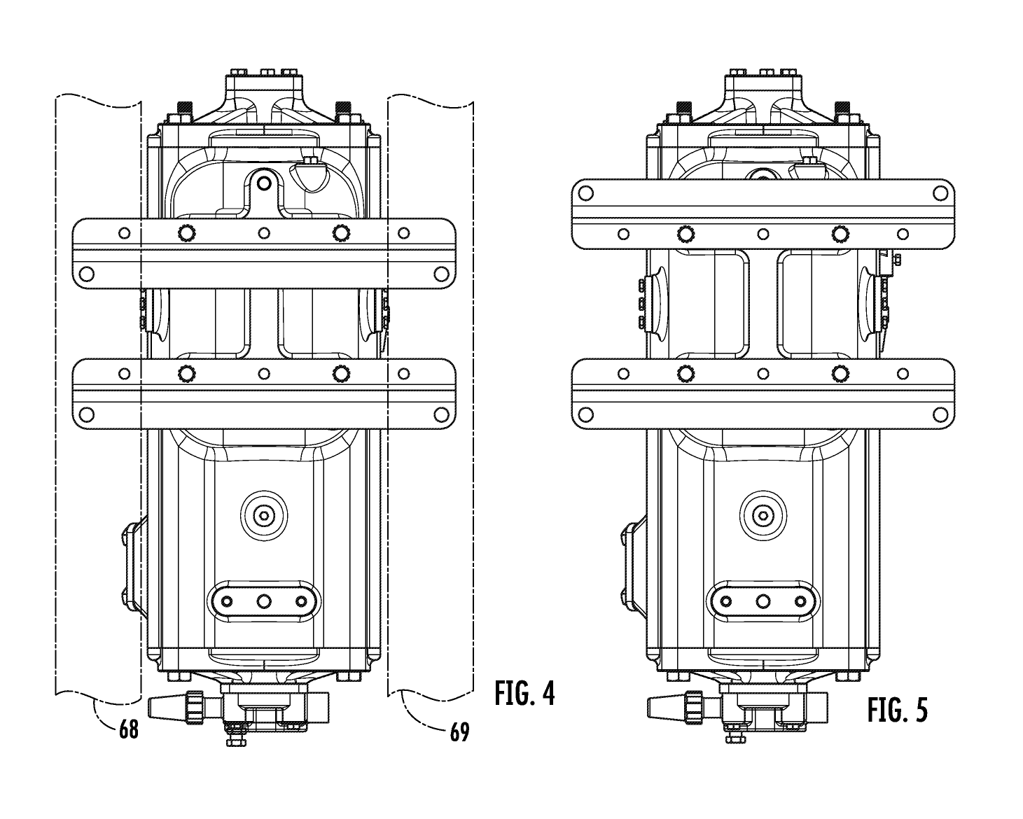

FIGS. 4 and 5 show two exemplary such transverse feet options wherein the feet are mounted transversely using the mounting feature pairs 50A and 50B and 52A and 52B (see FIG. 1). With the exemplary feet, there are several different orientation combinations as is discussed further below. In this exemplary situation, the rack mounting rails 68 and 69 are shown as longitudinal.

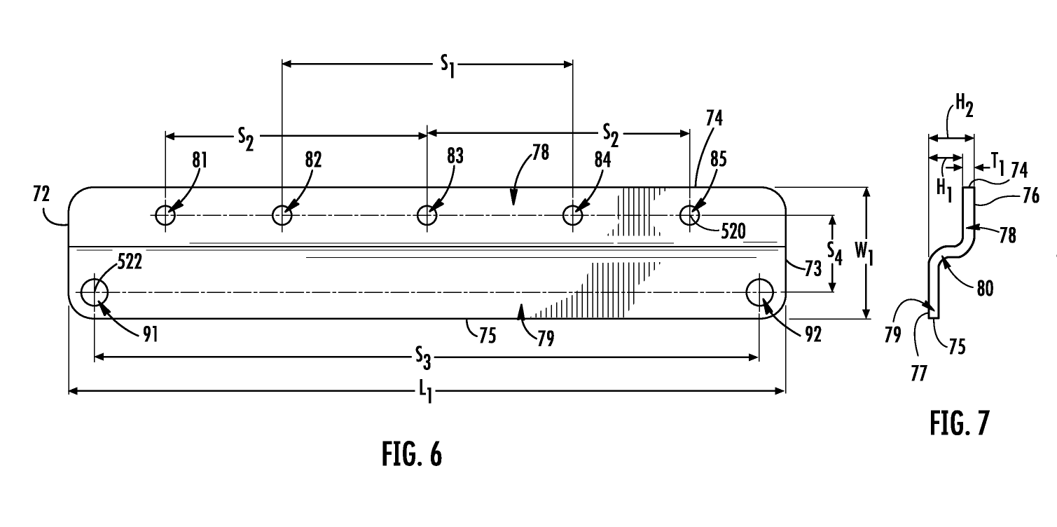

FIGS. 6 and 7 show one of the feet 70. The exemplary feet 70 are identical to each other (as opposed to being non-identical mirror images). The exemplary feet are elongate and are formed from a bent strip of bar stock (or cut in strips from a larger sheet). The exemplary feet extend from a first end 72 to a second end 73 and have respective first and second edges 74 and 75. The exemplary edges 74 and 75 may be formed by edges of the bar stock (e.g., aluminum or steel). The exemplary feet each have a first face 76 and a second face 77 (e.g., formed by opposite faces of the strip or bar stock). The exemplary feet are formed with first and second flat flange portions 78 and 79 respectively extending inward from the edges 74 and 75 and joined by a nearly S-curved transition portion 80 to offset the flange portions 78 and 79 from each other in a generally parallel relationship by a height H₁. An overall height is shown as H₂ which is merely H₁ plus the bar/strip thickness T₁. An overall length is L₁ and an overall width is W₁. Alternative constructions include cast or forged feet.

In the exemplary embodiment, the flange 78 has an array of mounting features shown as mounting holes 81, 82, 83, 84, and 85 each having an associated axis 520. Various combinations of these are complementary to various combinations of the compressor mounting features to permit the various mounting orientations discussed herein. In the exemplary implementation, the hole 83 is centrally positioned and the inboard or intermediate pair of adjacent holes 82, 84 are evenly spaced therefrom as are the outboard/distal/end holes 81, 85. An exemplary spacing between the intermediate pair of holes 82, 84 is shown as S₁ An exemplary separation between the center hole 83 and end holes 81, 85 is shown as S₂. The exemplary holes 81-85 are parallel to and in line with each other and are circular of a shared diameter.

Similarly, the second flange 79 may have a plurality of mounting features (e.g., holes) for mounting to the environmental structure (e.g., the rack rails). Exemplary features are a pair of mounting holes 91 and 92 each having an axis 522 and separated by a distance S₃.

The exemplary foot is thus a mirror image across a transverse centerplane in which the axis 520 of the hole 83 lies.

To allow for the alternative mounting, the exemplary spacing between the left and right compressor mounting holes 50A, 50B and 52A, 52B is also S₁ so that the feet may be mounted via holes 82 and 84 in the transverse conditions. As mentioned above, there are four possible combinations of mounting the feet transversely depending upon whether the edge 75 (the lower edge along the flange 79 for mounting to the environmental structure) faces forward or aft for each of the two feet. In general, the broader stance of FIG. 5 might be preferred. However, other considerations may influence orientation.

In the exemplary compressor, the mounting feature pairs 50A, 50B and 52A, 52B are relatively forward on the compressor with the feature pair 52A, 52B being nearly geometrically central. For the longitudinal feet orientation of such a compressor, it may be desired to mount the feet longitudinally off center. Accordingly, rather than dimensioning the system such that the same foot holes are used to mount the feet longitudinally as were used in the transverse mounting, the exemplary system mounts the feet longitudinally using the center hole 83 and one of the end holes 81, 85. In this example, the center hole of each foot is mounted to the intermediate mounting feature 52A or 52B and one of the end holes is mounted to the front mounting feature 50A, 50B. Again, there are several possible orientations of whether the feet lower edges face outward or inward. However, having the broadest stance favors the outward orientation of both feet as is shown in FIGS. 1-3.

Among other variations, resilient isolators (e.g., cylindrical elastomeric bodies) may intervene between the feet and the rails. A variety of isolation mounts including such elastomers and/or metallic compression springs are known as are a variety of mounting means (e.g., simple through-bolting of the feet to the rails or separate attachment of the isolation mount to the rails and the feet to the isolation mount).

Yet other variations include use of the other mounting features. For greater support, an adaptor may be used to mount one of the transverse feet to the aft mounting features 54A and 54B.

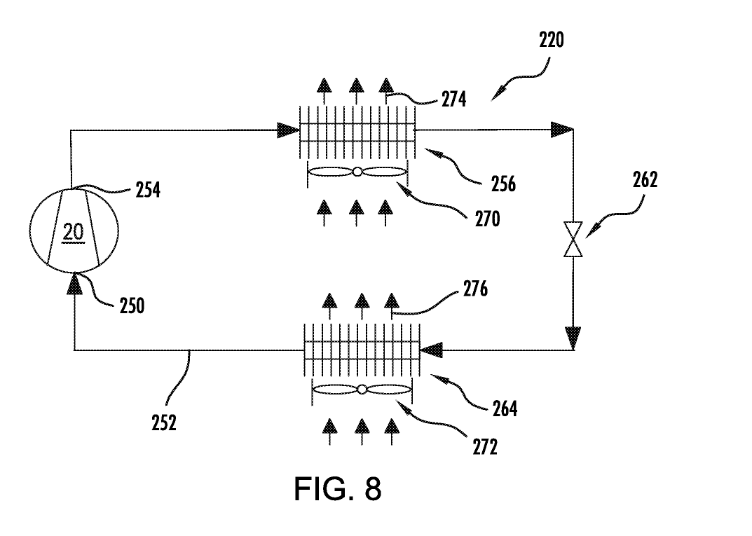

FIG. 8 shows an exemplary refrigeration system 120 including the compressor 20. The system 120 includes a system suction location/condition 150 at the suction port 26. A refrigerant primary flowpath 152 proceeds downstream from the suction location/condition 150 through the compressor cylinders in parallel to be discharged from a discharge location/condition 154 at the discharge port 28. The primary flowpath 152 proceeds downstream through the inlet of a first heat exchanger (gas cooler/condenser) 156 to exit the outlet of the gas cooler/condenser. The primary flowpath 152 then proceeds downstream through an expansion device 162. The primary flowpath 152 then proceeds downstream through a second heat exchanger (evaporator) 164 to return to the suction condition/location 150.

In a normal operating condition, a recirculating flow of refrigerant passes along the primary flowpath 152, being compressed in the cylinders. The compressed refrigerant is cooled in the gas cooler/condenser 156, expanded in the expansion device 162, and then heated in the evaporator 164. In an exemplary implementation, the gas cooler/condenser 156 and evaporator 164 are refrigerant-air heat exchangers with associated fan (170; 172)-forced airflows (174; 176). The evaporator 164 may be in the refrigerated space or its airflow may pass through the refrigerated space Similarly, the gas cooler/condenser 156 or its airflow may be external to the refrigerated space.

Additional system components and further system variations are possible (e.g., multi-zone/evaporator configurations, economized configurations, and the like). Exemplary systems include refrigerated transport units and fixed commercial refrigeration systems.

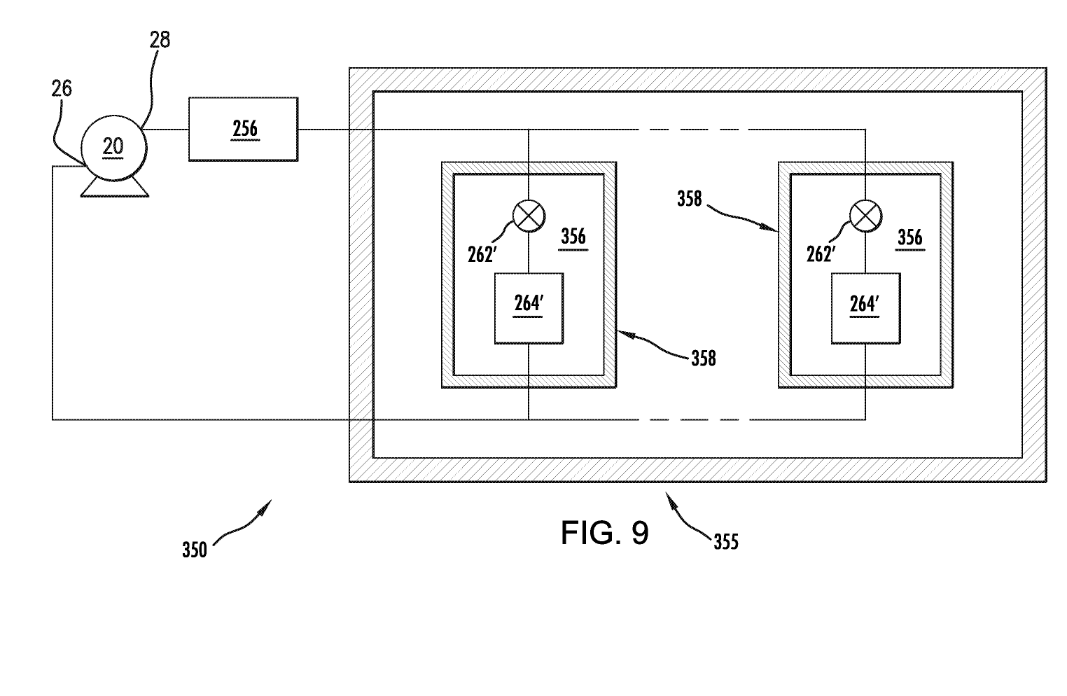

An exemplary fixed commercial refrigeration system 250 (FIG. 9) includes one or more central compressors 20 and heat rejection heat exchangers 156 (e.g., outside/on a building 255) commonly serving multiple refrigerated spaces 256 (e.g., of retail display cabinets 258 in the building). Each such refrigerated space may have its own heat absorption heat exchanger 164′ and expansion device 162′ (or there may be a common expansion device). Other rack-mount situations include building heating, ventilation and air conditioning (HVAC).

The compressor may be manufactured via otherwise conventional manufacturing techniques.

Although an embodiment is described above in detail, such description is not intended for limiting the scope of the present disclosure. It will be understood that various modifications may be made without departing from the spirit and scope of the disclosure. For example, when implemented in the reengineering of an existing compressor configuration, details of the existing configuration may influence or dictate details of any particular implementation. Accordingly, other embodiments are within the scope of the following claims.

1. A compressor (20) comprising:
a case (22); and
a pair of feet (70A, 70B),
wherein the feet are alternatively mountable in:
a first orientation; and
a second orientation orthogonal to the first orientation.

2. The compressor of claim 1 wherein:
the compressor is a reciprocating compressor.

3. The compressor of claim 1 further comprising:
an electric motor (24) within the case for driving compression.

4. The compressor of claim 1 wherein:
the feet comprise bent sheet metal strips.

5. The compressor of claim 1 wherein:
the case comprises a casting with internally-threaded mounting features (50A, 50B, 52A, 52B, 54A, 54B); and
the feet comprise complementary mounting features (81, 82, 83, 84, 85).

6. The compressor of claim 5 wherein:
the case internally-threaded mounting features include a first pair (50A, 50B) laterally spaced apart and a second pair (52A, 52B) laterally spaced apart and longitudinally spaced apart from the first pair.

7. The compressor of claim 6 wherein:
the feet complementary mounting features comprise:
a pair of holes (82, 84) mountable, respectively, to the first pair of internally-threaded mounting features or the second pair of internally-threaded mounting features in the first orientation; and
at least two further holes (83, 81; 83,85) mountable, in the second orientation, respectively to one of the internally-threaded mounting features of the first pair and one of the internally-threaded mounting features of the second pair.

8. The compressor of claim 7 wherein:
a first hole of said at least two further holes in the feet is between the holes of the pair.

9. The compressor of claim 8 wherein:
the first hole is exactly between the pair.

10. The compressor of claim 7 wherein:
the case further comprises a shared boss bearing the mounting features.

11. The compressor of claim 1 wherein:
the feet are secured to support rails, spanning a gap between the rails.

12. A system (120; 250) comprising:
the compressor (20) of claim 1;
a refrigerant recirculating flowpath (152) through the compressor;
a first heat exchanger (156) along the flowpath downstream of the compressor;
an expansion device (162; 162′) along the flowpath downstream of the first heat exchanger; and
a second heat exchanger (164; 164′) along the flowpath downstream of the expansion device.

13. The system of claim 12 wherein:
a refrigerant charge comprises at least about 50% carbon dioxide or fluorocarbon by weight.

14. The system of claim 12 being a fixed refrigeration system further comprising:
multiple refrigerated spaces (256); and
a plurality of said second heat exchangers (164′), each being positioned to cool an associated said refrigerated space.

15. A method for manufacturing a plurality of the compressors of claim 1 comprising:
with a first said compressor, mounting the pair of feet in the first orientation; and
with a second said compressor, mounting the pair of feet in the second orientation, the second compressor's case and feet being identical to the first compressor's case and feet.

16. The method of claim 15 wherein:
with the first said compressor the feet are secured to first support rails, spanning a gap between the first support rails; and
with the second said compressor the feet are secured to second support rails, spanning a gap between the second support rails.

17. The compressor of claim 3 wherein:
the electric motor has a central longitudinal axis (500);
in the first orientation, the feet are parallel to the central longitudinal axis; and
in the second orientation, the feet are orthogonal to the central longitudinal axis.
